(19) United States
(12) Patent Application Publication
(10) Pub. No.: US 2003/0046711 A1
(43) Pub. Date: Mar. 6, 2003

(54) Formatting a file for encoded frames and the formatter

(76) Inventors: Chenglin Cui, Succasunna, NJ (US); Kai X. Miao, Boonton Twp, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/882,939

(22) Filed: Jun. 15, 2001

(51) Int. Cl. H04N 7/173

(52) U.S. Cl. 725/134

(57) ABSTRACT

The present invention is in the field of delivery and storage of real-time data in communications networks. More particularly, the present invention provides a method, apparatus, system, and machine-readable medium to store an encoded audio or video stream.

### FIELD OF INVENTION

The present invention is in the field of delivery and storage of real-time data in communications networks. More particularly, the present invention provides a method, apparatus, system, and machine-readable medium to store an encoded audio or video stream.

### BACKGROUND

The internet may be used to transmit audio or video from one location to a second location. Audio and video may be encoded into frames by a compressor/decompressor (codec) and packeted. An Internet gateway may transmit the packets to another location but may only transmit packets comprising active frames, reducing the chance of overloading a node on an Internet Protocol (IP) network. For example, a module for a speech codec may recognize when substantially only background noise is being processed so the speech codec may output a silence insertion descriptor (SID) to the gateway. The SID may describe a pattern for the background noise of the silence frame, such as comfortable noise, rather than outputting a full size active frame for each silence frame. Then, the gateway may transmit a SID packet but may refrain from transmitting packets for the subsequent silence frames.

When a gateway refrains from transmitting packets, the receiver may, for example, play the comfortable noise until an active frame is received. However, when the active frames are stored in a file for decoding and play back at a later time, the silence frames may be lost, losing the ability to recreate the temporal information in the audio or video.

In addition, a station can require complex software to interpret and playback encoded frame files that comprise active frames of a first size intermixed with comfortable noise descriptions of a second size.

### BRIEF FIGURE DESCRIPTIONS

The accompanying drawings, in which like references indicate similar elements, show:

FIG. 1 depicts a phone or video coupled to a station via a gateway and network.

FIG. 2 depicts a microprocessor coupled to a network interface to format a file for an encoded frame.

FIG. 3 depicts a flow chart to format a file for an encoded frame.

FIG. 4 depicts another flow chart to format a file for an encoded frame.

FIG. 5 depicts a machine-readable medium comprising instructions to format a file for an encoded frame.

FIG. 6A depicts an example encoded speech frame.

FIG. 6B depicts an example silence insertion descriptor (SID).

FIG. 6C depicts an example silence description frame.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments. The variations of embodiments anticipated for the present invention are too numerous to discuss individually so the detailed descriptions below are designed to make such embodiments obvious to a person of ordinary skill in the art.

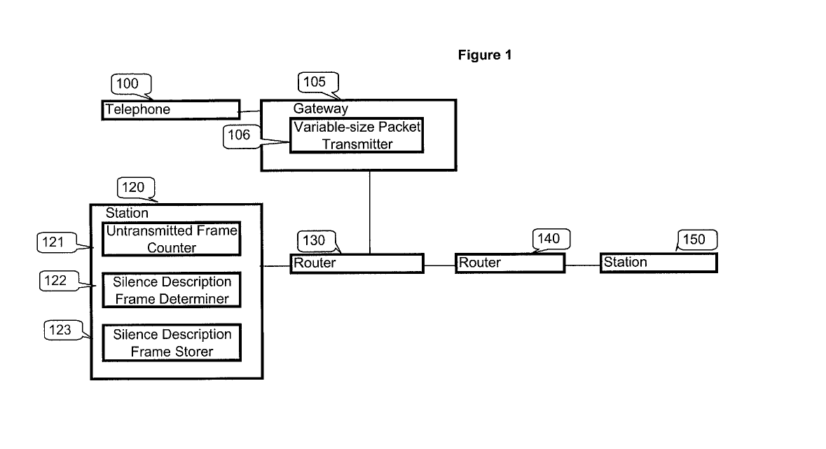

Referring now to FIG. 1, there is shown a network capable of transmitting audio frames in the form of packets from audio equipment, such as telephone 100, to a station 120, station 120 to station 150, and from station 120 to audio equipment. In particular, telephone 100 may be a standard analog telephone and can be coupled to gateway 105 via plain old telephone service (POTS).

Gateway 105 may receive analog audio input, digitize and convert the analog signal into encoded frames, and packet the encoded frames. The audio input may be encoded by a low bit rate speech codec, for example. The packets may be transmitted from gateway 105 to station 120 via an internet protocol (IP). Further, gateway 105 may output discontinuous packets via a variable-size packet transmitter 106 comprising a protocol such as discontinuous transmission mode (DTX) to reduce traffic on the network. Routing discontinuous packets can limit gateway 105 to forward packets to station 120 when packets comprise at least a minimum amount of data. When a packet comprises less than the minimum amount of data then a packet of smaller size or no packet at all may be transmitted to station 120 via router 130. For example, the variable-size packet transmitter 106 may also comprise a voice activity detector (VAD) to determine whether audio levels or frames represent an active speech frame or a silence frame.

Station 120 may be a workstation or server of the local area network (LAN) and may comprise a silence description frame filer, software in this embodiment to receive the packets and store them on a hard drive, tape drive, or in memory as a file of encoded frames. The silence description frame filer may comprise an untransmitted frame counter 121, a silence description frame determiner 122, and a silence description frame storer 123. When gateway 105 determines that no packet should be forwarded, untransmitted frame counter 121 may count an untransmitted frame, a silence frame purposefully not sent by gateway 105. The untransmitted frame counter 121 may determine station 120 received an untransmitted frame when station 120 does not receive a frame or packet comprising frames. In some embodiments, the untransmitted frame counter 121 may count an untransmitted frame after determining a packet was not lost or dropped. In other embodiments, the untransmitted frame counter 121 may count an untransmitted frame as a result of communication between protocol modules in the gateway 105 and station 120. Further embodiments can count an untransmitted frame by determining a packet with a sequence number or time stamp was not received.

In many embodiments, prior to receiving a silence frame, station 120 may receive a packet describing a silence frame. The packet may be smaller than fixed size packets of active frames. Packets comprising data describing silence frames may comprise packets describing background noise or comfortable noise, such as a silence insertion descriptor (SID).

Station 120 may store the active and silence frames received from telephone 100 via gateway 105 in one or more files. The files can be executed at a later time to replay or rebroadcast the audio transmissions from telephone 100. The one or more files can comprise an audio frame such as a speech frame and a silence description frame. The silence description frame determiner 122 may determine a silence description frame equivalent in size to an audio frame and the silence description frame may comprise a first pattern, a silence frame count, and a second pattern. The silence description frame can be designed to comprise a fixed-size equivalent to the size of the corresponding fixed-size active frame to facilitate interpretation of the encoded frame by a codec that may not be designed to fully interpret the silence description frame or at least prevent the codec from failing to decode the accompanying active frame.

In some embodiments, the silence description frame may comprise data describing background noise or comfortable noise, such as a silence insertion descriptor (SID), or a portion thereof. The first pattern may comprise a pattern of data to distinguish the silence description frame from an active frame, such as a speech frame, to indicate the beginning of the silence description frame. The first pattern may also be designed to appear to be part of an SID or an invalid frame. Thus, a codec that is not equipped to interpret a silence description frame may either interpret the silence description frame as an SID for a single silence frame or as a lost frame.

The silence frame count can comprise data indicating the number of untransmitted frames and the second pattern may comprise a pattern to indicate the end of the silence description frame. For example, gateway 105 may transmit encoded audio frames to station 120 in the form of speech frame packets of fixed-size and SID packets. The speech frames may comprise ten bytes each and the SID packets may comprise two bytes each. After each SID packet, gateway 105 may transmit no data or zero byte frames. Station 120 may receive a speech frame and store the speech frame in a file. Then station 120 may receive the SID packet and begin to determine the number of untransmitted frames.

Upon receiving an SID packet, silence description frame storer 123 may begin to store a silence description frame in the file. The first pattern may be a default pattern stored in station 120 or may be determined by a software module in station 120. Until the station 120 completes a count of silence frames, the silence description frame may comprise the first pattern of four bytes and the two SID bytes. When the station completes the count of silence frames a two-byte count for the silence frames may be stored in the silence description frame. Lastly, a second pattern may be stored at the end in the last two bytes of the silence description frame. Thus, the silence description frame may comprise a ten byte frame that is equivalent in size to the ten byte speech frame.

Upon storing a file comprising the active frames and silence description frames, a decoder of station 120 may replay or rebroadcast the audio. Station 120 can replay or rebroadcast a file to an output device coupled to station 120, interpreting the silence description frames as the number of silence frames in the silence frame count when station 120 comprises a decoder capable of interpreting the silence description frame completely. Each silence frame may be decoded as comfortable noise in a pattern described in SID bytes when available.

In addition, station 120 may transmit the file to another station, such as station 150. Transmitting the file can comprise attaching the file to an e-mail and forwarding the e-mail via router 130 and router 140 to station 150. Station 150 can initiate a codec to decode the audio frames and silence description frames. When station 150 does not comprise software to interpret the number of silence frames represented by the silence description frame, the decoder may still decode the audio frames. The decoder may insert a single silence frame upon interpreting the silence description frame or interpret the silence description frame as invalid and treat the frames as a lost frame.

In some embodiments, station 120 may re-transmit the file in a pattern of packets. For instance, station 120 may be designed to broadcast the audio frames of the file on demand. A telephone such as telephone 100 may transmit a transaction via gateway 105 to station 120 requesting the file be broadcast or transmitted to telephone 100. Station 120 may forward each speech frame packet and SID packet to telephone 100 via gateway 105. Gateway 105 may contain the codec to decode the speech frame as well as DTX and VAD modules to handle the variable size and discontinuous packets.

In alternate embodiments, a video device may be coupled to gateway 105 comprising a video camera or video player. The video device may comprise an analog output and gateway 105 may comprise an adaptive differential pulse code modulation (ADPCM) module at the video input to take the difference between a video frame at a first time and a video frame at a second time to generate a packet comprising the difference. When the amount of data to describe the difference between the video frame at time 1 and the video frame at time 2 is below a minimum size, a filter can determine that no packet may be transmitted, i.e. a silence frame. The remainder of the video frames may be fixed in size to one or more fixed sizes. Thus, station 120 may count the untransmitted frames, determine a silence description frame, and store the video and silence description frames in a file to be decoded at a later time. Many of these embodiments determine a silence description frame to be interpreted as an invalid frame.

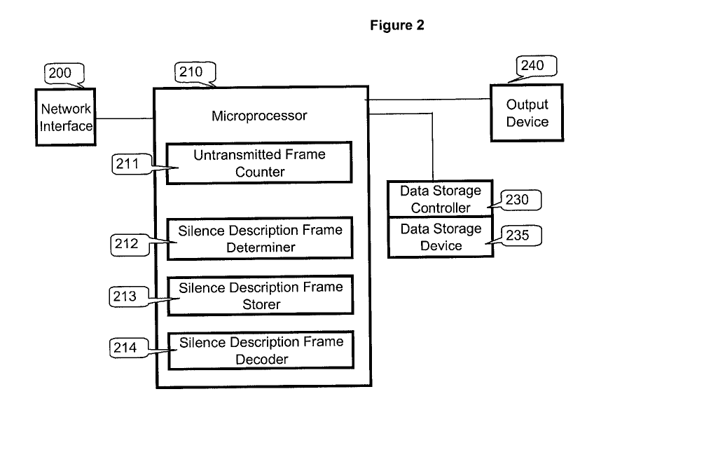

Referring now to FIG. 2, there is shown an apparatus to format an encoded file. The apparatus may comprise a microprocessor 210 to receive packets comprising an audio frame or SID. Microprocessor 210 may be coupled to a network interface 200, a data storage device 235, and an output device 240. Packets may be received via network interface 200 from an Internet Protocol (IP) telephone system. The IP telephone system may comprise a cellular phone transmitting encoded audio frames via time division multiple access (TDMA) or code division multiple access (CDMA) coupled to a gateway. The gateway packets audio frames from the cellular telephone into variable size packets to transmit via an IP network to a destination for filing audio frames, such as a location comprising a station to store voice mail. The use of an IP network to transmit the audio frames may reduce the use of phone lines.

The network interface 200 may be coupled to a gateway and the gateway may be coupled to the cellular telephone. The gateway may packet active speech frames and attach a sequence number or time stamp to a SID packet and/or active frame packet, facilitating a count of untransmitted frames by untransmitted frame counter 211. Other embodiments may comprise a separate Internet protocol path between network interface 200 and the gateway to transmit a time index or sequence number separate from the SID and active frame packets. Further embodiments may be designed for real-time receipt of audio frames and may determine the count of untransmitted frames from the elapsed time, a determined or selected network path latency, and the amount of time represented by each active frame.

Packet transmissions for audio frames may comprise many untransmitted frames. For example, a conversation between two people may comprise sixty percent silence. Thus when packeting audio frames, a system such as a gateway may reduce the traffic of packets on an IP network by transmitting only frames containing at least a specified amount of data. For instance, during the sixty percent silence of a conversation when the audio frames may consist essentially of background noise, the gateway may not transmit packets.

After transmitting an active packet, at the beginning of one or more silence frames, the gateway may transmit a packet comprising a SID. A comfortable noise module of an audio encoder such as a speech encoder may generate the SID when an audio frame comprises a silence frame. The comfortable noise module may measure the background noise of the speech and determine parameters to describe the background noise. The SID may comprise parameters to describe the background noise so that the noise can be reproduced to avoid unpleasant noise modulation when the transmission is switched off. Some comfortable noise modules may select a comfortable noise pattern and measure the ambient levels of background noise. In other embodiments, a decoder may determine the ambient noise from ambient noise in active frames.

The data storage device 235 may comprise instructions for microprocessor 210 such as codecs and data frame enhancement techniques. Audio codecs may comprise codecs such as pulse code modulation (PCM), adaptive differential pulse code modulation (ADPCM), global system for mobile communications (GSM), etc.

Data frame enhancement software may comprise enhancements such as automatic gain enhancement, noise cancellation, echo cancellation, error detection and handling, jitter management and a bypass codec module. Automatic gain enhancement software may maintain consistent, continuous gain levels. Noise cancellation and echo cancellation software can clear up sound. Error detection in handling software can comprise error detection for corrupt bits within packets and error detection for dropped packets. When forwarding several packets through a network, bits of a packet may become corrupt and error detection may recognize the corrupt bits and correct or attenuate the error. Dropped packets, on the other hand, may require transmitting a request for a retransmission of the packet.

Jitter management software may add minimal delays in transmission of packets to facilitate smooth operation of a network. For instance, a node on a network may switch or route packets from many sources to many target devices and when a node approaches it maximum routing or switching limit, then it may begin to drop packets.

Bypass codec software may facilitate multiplexing data, voice and data on the same network path. The bypass codec software may allow transmissions such as faxes and dual-tone multi-frequency transmissions to transmit in uncompressed packets since some codecs may corrupt fax and dual-tone multi-frequency data.

The microprocessor 210 may comprise an untransmitted frame counter 211, a silence description frame determiner 212, a silence description frame storer 213, and a silence description frame decoder 214. The untransmitted frame counter 211 may count untransmitted frames via network interface 200. When the SID packet comprises a sequence number or time-stamp, the untransmitted frame counter 211 may count the number of silence frames by comparing the sequence numbers or time stamps on the files received since each frame may be a fixed length. For example, when each frame is 30 milliseconds and one hundred sequence numbers are missing, one hundred silence frames (three seconds of silence) may be counted. Further, the gateway may instead establish a second network path and use the path to indicate a number of silence frames, a count of frames, or a time count so the untransmitted frame counter 211 may count the number of silence frames.

In other embodiments, the untransmitted frame counter 211 may not receive a packets comprising frames for a period of time during the transmission of audio packets from the gateway. The untransmitted frame counter 211 may track the time elapsed between packets for real-time applications or may perform an error check to determine whether a packet was lost or dropped between the gateway and microprocessor 210. Since the audio frames may be stored in a file for decoding at a later time, the untransmitted frame counter 211 may initiate a transaction to the gateway to verify a packet was not lost or dropped and to request the packet be re-transmitted if the packet was lost or dropped.

The silence description frame determiner 212 and a silence description frame storer 213 may store an audio frame and a silence description frame in a file in data storage device 235 via data storage controller 230. The silence description frame determiner 212 may select or determine a silence description frame based upon the codec used to encode the audio files by the gateway. For instance, when the encoder, a low bit rate speech codec, generates a speech frame comprising ten bytes of encoded data, the silence description frame determiner 212 may select or determine a silence description frame comprising and equal number of bytes, i.e. ten bytes. Further, the silence description frame determiner 212 may also select or determine a silence description frame based upon the presence of a SID and the size of the SID. Thus, when the SID is two bytes and the active frame is ten bytes, the silence description frame may insert eight bytes of data comprising four bytes for a first pattern, two bytes for a silence frame count, and two bytes for a second pattern. The first pattern may demarcate the silence description frame for a decoder. A decoder can begin to read the silence description frame at the first pattern, recognize that the first pattern does not include audio data, and initiate a module or thread to interpret the silence description frame. In alternate embodiments, a decoder may not comprise a module or thread to interpret the silence description frame so the silence description frame can be interpreted by a decoder as an invalid frame.

The silence frame count may comprise the count of untransmitted frames and the second pattern may demarcate the end of the silence description frame. Once a module or thread begins to interpret a silence description frame, the second pattern may only need to be distinguishable from the silence frame count. The second pattern may act as filler or may be removed in some embodiments where a module or thread can determine or recognize the size and pattern of the silence description frame from the first pattern or by some other method such as the thread or module is only designed to encounter one pattern of silence description frame.

The silence description frame storer 213 may store a file comprising one or more audio frames separated by silence description frames. The audio frames may comprise encoded audio by an audio codec. For example, an encoder may output a 24-byte data frame representing 30 milliseconds of speech. The encoder may then output a four-byte SID frame followed by one or more untransmitted frames.

Microprocessor 210 may output audio via output device 240. For instance, the silence description frame decoder 214 may execute an audio codec from data storage device 235 to decode a file comprising speech frames and silence description frames. The audio codec may decode the speech to output via output device 240 and may be capable of fully decoding the silence description frame so the silence description frame decoder 214 may generate the comfortable noise to simulate the silence period for the number of frames described in the silence description frame. Then, the audio codec may decode any additional active frames.

In some embodiments, when the decoder in data storage device 235 does not recognize the silence description frame, the decoder may recognize the SID bytes in the silence description frame and can output a single silence frame between active speech frames. The silence frame may comprise comfortable noise as determined by the encoder and described by the parameters in the SID. In other embodiments, the decoder may interpret the silence description frame as invalid and treat it as a lost frame.

In alternative embodiments, video packet transmissions may comprise untransmitted frames. For example, a video clip may comprise more than sixty percent footage that does not change from frame to frame.

Video encoders may separate unchanging displays and changing displays into separate objects. The unchanging display object may be transmitted once for the video clip and the changing display object may be encoded in video frame packets. The video frame packets may describe the difference between the video display of the previous frame and the video display of the frame described by the packet by waveform encoder such as an ADPCM encoder. The significant portion of the changing object may remain unchanged from frame to frame and some frames not change at all. For example, a video clip may display an unmoving landscape for several frames. Thus, when packeting encoded video frames, a system such as a gateway may reduce the traffic of packets on an IP network by transmitting only frames containing data or containing a minimum amount of data. In video files when there is a minimum amount of change in the active object of the video, the gateway may not transmit packets.

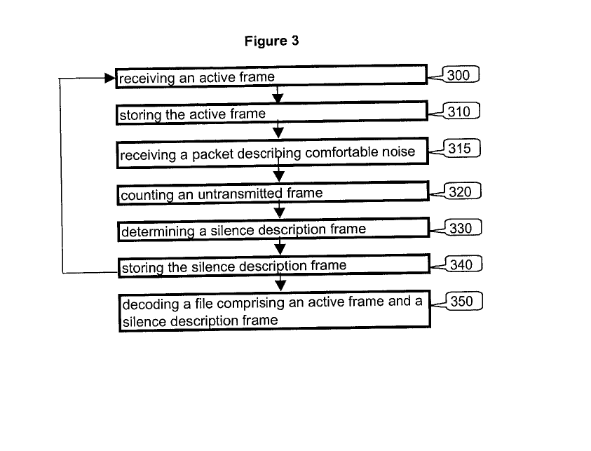

Referring now to FIG. 3, there is shown a flow chart of embodiments to format an encoded file. The flow chart comprises receiving an active frame 300, storing the active frame 310, receiving a packet describing comfortable noise 315, counting an untransmitted frame 320, determining a silence description frame 330, storing a silence description frame 340, and decoding a file comprising an active frame and a silence description frame 350. Receiving an active frame 300 may comprise receiving a packet via an IP network comprising audio such as speech. The audio may be encoded via a low bit rate speech codec of a gateway near the audio source. Storing the active frame 310 may comprise storing the bytes of the active frame in a file. Storing the active frame 310 can allow an active frame transmission to be copied and forwarded to stations, such as by email and can allow the transmission to be decoded at any time rather than just real-time.

Counting an untransmitted frame 320 may determine that the absence of receipt of a packet represents a silence frame in the active frame transmission. Counting an untransmitted frame 320 can comprise determining that a packet of a sequence of packets was not received by monitoring a sequence number attached to a packet, monitoring a sequence number associated with a packet, receiving a time stamp attached to the packet, or receiving or determining a time stamp associated with the packet. In some embodiments, the time stamp associated with the packet can be transmitted on a network path by the gateway being maintained in parallel with a path for packets comprising active frames. In other embodiments, the time stamp associated with the packet can be transmitted along the same path prior to, or subsequent to, a packet comprising an active frame.

Further embodiments may comprise error detection that may determine when the absence of receipt of a packet is due to loss of the packet during transmission through the network and, alternatively, when the absence of a packet represents a silence frame or frame. Many of these embodiments comprise jitter management software that can work in conjunction with the error detection and handling software to determine when lack of receipt of a packet is the result of a jitter management measure.

In addition, counting an untransmitted frame 320 may comprise determining an untransmitted frame represents a silence frame. Determining an untransmitted frame represents a silence frame may comprise receiving a silence insertion descriptor packet to describe comfortable noise to insert during silence frames. In some embodiments, the comfortable noise may be a pattern described by parameters selected from, determined from, or selected in view of background noise of the encoded active frame or the silence frame.

Determining a silence description frame 330 may comprise selecting a format for a silence description frame based on attributes of the codec used to encode the active frame file, the presence or absence of a SID packet, and a silence frame count. The codec used to encode the audio may determine the size of the active frame and the silence description frame can be an equivalent size. A decoder that does not comprise a module or thread to interpret the silence description frame may interpret an equivalent size frame but be unable to interpret a different size frame. In some embodiments, a first pattern byte or bytes may be selected based upon the codec used to encode the active frames. In alternative embodiments, the first pattern byte or bytes may be designed or selected based on an active frame. When a SID packet is received, the SID bytes may be extracted from the packet and inserted in the silence description frame.

Determining a silence description frame 330 may also comprise determining a silence frame count. Determining a frame count may comprise counting the number of untransmitted frames that represent silence frames. A second pattern byte or bytes may be selected or designed from the selected codec or active frame, similar to a first pattern byte or bytes, to distinguish the end of the silence description frame and/or to demarcate the end of the silence frame count.

Storing a silence description frame 340 may store a silence description frame between active frames. In some embodiments, a silence description frame may also be stored prior to an active frame or subsequent to a final active frame in a file. Storing a silence description frame 340 can comprise storing a first pattern byte or bytes, a SID byte or bytes, a silence frame count byte or bytes, and a second pattern byte or bytes adjacent to active frames. For instance, when an active frame comprises 20 bytes and a SID comprises four bytes, the silence description frame can comprise 20 bytes. A silence description frame may comprise a first pattern having eight bytes, a SID having four bytes, a silence frame count having two bytes, and a second pattern having six bytes.

Receiving an active frame 300 may begin again upon storing the silence description frame 340. The cycle can repeat until a all active frames and silence description frames are stored in a file. The process may end after the transmission of packets for the original audio broadcast since an error-checking module or thread may request retransmission of packets that have not yet been counted as untransmitted packets.

Decoding a file comprising an active frame and a silence description frame 350 may replay a file comprising active frames and silent description frames. Decoding a file comprising an active frame and a silence description frame 350 can comprise executing a module or initiating a thread to interpret a silence description frame. In other embodiments, decoding a file comprising an active frame and a silence description frame 350 may comprise decoding active frames and treating silence description frames as lost frames.

In further embodiments, the active frames may comprise video difference frames. In some embodiments, an additional module or thread may verify that a SID packet was received and/or the number of untransmitted frames is within a reasonable range.

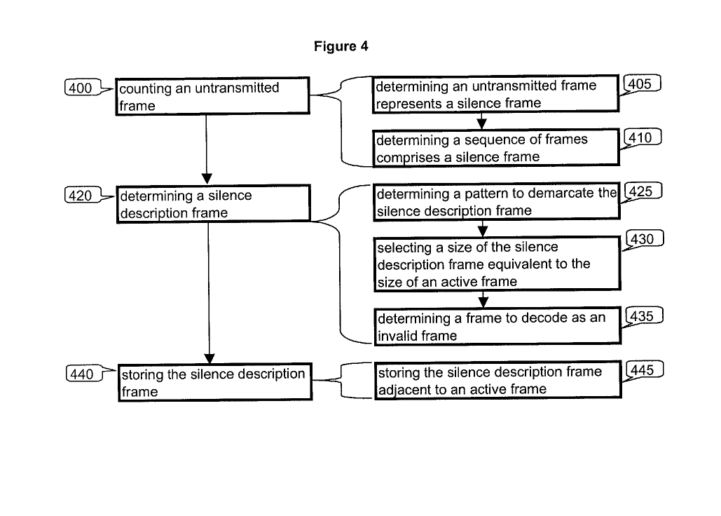

Referring now to FIG. 4, there is shown a flow chart of embodiments to format an encoded file. The embodiment comprises counting an untransmitted frame 400, determining a silence description frame 420, and storing the silence description frame 440. Counting an untransmitted frame 400 may comprise determining an untransmitted frame represents a silence frame 405 and determining a sequence of frames comprises a silence frame 410. Determining an untransmitted frame represents a silence frame 405 may comprise receiving a packet such as a SID packet and determining that the packet identifies a silence frame or it identifies the start of more than one silence frames. In some embodiments, determining an untransmitted frame represents a silence frame 405 may comprise determining from a counter that a packet comprising a frame should have been received and determining that the non-receipt of the packet indicates a silence frame or receiving an indication that a frame should be received but receiving no frame, indicating a silence frame. Many embodiments comprise receiving a counter type packet on the same network path leading or subsequent to each packet comprising data or silence frames. Further, some embodiments comprise verifying that the non-receipt of a packet represents a silent frame such as by checking for error, checking for lost or dropped packet indications, requesting a retransmission of a packet, or requesting that the missing packet be confirmed as untransmitted.

Determining a sequence of frames comprises a silence frame 410 may determine that a packet in a sequence of packets was not received and the non-receipt of that packet or packets in a sequence of packets indicates a silence frame(s) or that a packet with a time stamp or a series of packets with time stamps were not received and the non-receipt indicates a silence frame. In some embodiments, determining a sequence of frames comprises a silence frame 410 can comprise receiving a time count on a separate network path indicating when packets should be received.

Determining a silence description frame 420 may select a format matching a codec used to compress audio frames such as from a list of formats. Determining a silence description frame 420 can comprise determining a pattern to demarcate the silence description frame 425, selecting a size of the silence description frame equivalent to the size of an active frame 430, and determining a frame to decode as an invalid frame 435. Determining a pattern to demarcate the silence description frame 425 may determine a pattern for a codec that will demarcate the silence description frame from frames encoded by the codec. Determining a pattern to demarcate the silence description frame 425 may also comprise determining a pattern that will be interpreted by the codec as noise, error, or substantially no change from a preceding active frame. In some embodiments, determining a pattern to demarcate the silence description frame 425 may comprise determining a modified SID frame or determining a pattern to mark the end of the silence description frame.

Selecting a size of the silence description frame equivalent to the size of an active frame 430 may select or determine a silence description frame the same size as an active frame encoded by a codec. For example, when a codec encoding speech frames creates a active frame comprising twenty bytes, selecting a size of the silence description frame equivalent to the size of an active frame 430 may select a silence description frame from a table of silence description frames comprising twenty bytes. In some embodiments, selecting a size of the silence description frame equivalent to the size of an active frame 430 may also comprise selecting a silence description frame that comprises a SID.

Determining a frame to decode as an invalid frame 435 can comprise selecting or designing a silence description frame, or a portion thereof, to cause a codec to interpret the frame as an invalid frame. The codec may treat invalid frames as lost or dropped frames, or may treat the frame as a single silence frame. When a codec treats a silence description frame as a silence frame, the codec may decode the frame as a frame of comfortable noise.

Storing the silence description frame 440 may comprise storing the silence description frame adjacent to an active frame 445. Storing the silence description frame adjacent to an active frame 445 can comprise inserting a silence description frame between active frames in a file for active frames and silence description frames. The file may be stored in permanent data storage such as non-volatile memory or on a hard disk. In many embodiments, storing the silence description frame adjacent to an active frame 445 can comprise storing a silence description frame prior to or subsequent to all the active frames in a file.

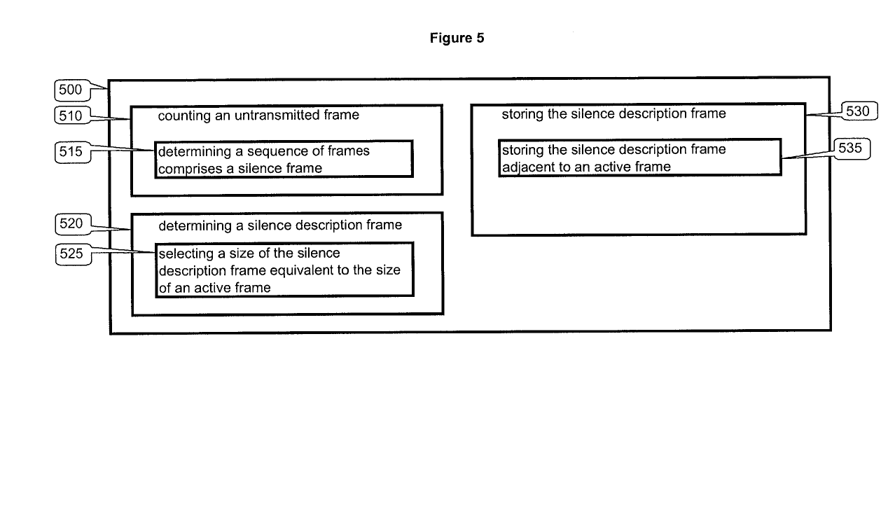

Referring now to FIG. 5, a machine-readable medium embodiment of the present invention is shown. A machine-readable medium includes any mechanism that provides (i.e. stores and or transmits) information in a form readable by a machine (e.g., a computer), that when executed by the machine, can perform the functions described herein. For example, a machine-readable medium may include read only memory (ROM); random access memory (RAM); magnetic disk storage media; optical storage media; flash memory devices; electrical, optical, acoustical or other form of propagated signals (e.g. carrier waves, infrared signals, digital signals, etc.); etc . . . . Several embodiments of the present invention can comprise more than one machine-readable medium depending on the design of the machine.

The embodiment 500 may comprise instructions for counting an untransmitted frame 510 and determining a silence description frame 520, and storing the silence description frame 530. Counting an untransmitted frame 510 may determine that a frame was not received because a frame was not transmitted and that the untransmitted frame represents a silence frame. Counting an untransmitted frame 510 can comprise determining a sequence of frames comprises a silence frame 515. Determining a sequence of frames comprises a silence frame 515 may determine that the untransmitted frame indicated a silence frame by comparing time stamps or sequence numbers of packets leading and packets received subsequent to the untransmitted frame or frames.

Determining a silence description frame 520 may determine the format of a frame to distinguish the frame from active frames and to represent one or more silence frames. In some embodiments, determining a silence description frame 520 may comprise determining a silence description frame that may be interpreted as a single silence frame by a codec rather than as one or more silence frames. Determining a silence description frame 520 can comprise selecting a size of the silence description frame equivalent to the size of an active frame 525 to determine a silence description frame the same size as an active frame. The silence description frame may comprise a first pattern to distinguish the silence description frame from an active frame and a trailing second pattern to indicate the conclusion of the silence description frame. Determining a silence description frame 520 can further comprise selecting a silence description frame to insert a SID and silence frame count.

Storing the silence description frame 530 can comprise instructions for storing the silence description frame adjacent to an active frame 535. Storing the silence description frame 530 can comprise storing the silence description frame in a file comprising active frames. In other embodiments, a silence description frame may be inserted between two silence description frames. For instance, during a period of silence, the comfortable noise parameters may change sufficiently or the silence may last long enough to for the encoder to forward a second and third SID. Storing a silence description frame 530 may store a silence description frame for each SID packet received. In other embodiments, the silence description frame may comprise bytes for data such as a first pattern, second pattern, and SID that comprises most of the silence description frame, limiting the size silence frame count. When the size of the silence frame count exceeds the allotted space, additional silence description frames may be stored in the file.

In some embodiments, storing the silence description frame 530 can comprise instructions for storing a frame comprising a first pattern to distinguish silence description frame from an active frame, a SID packet, a silence frame count, and a second pattern to indicate the conclusion of the silence description frame.

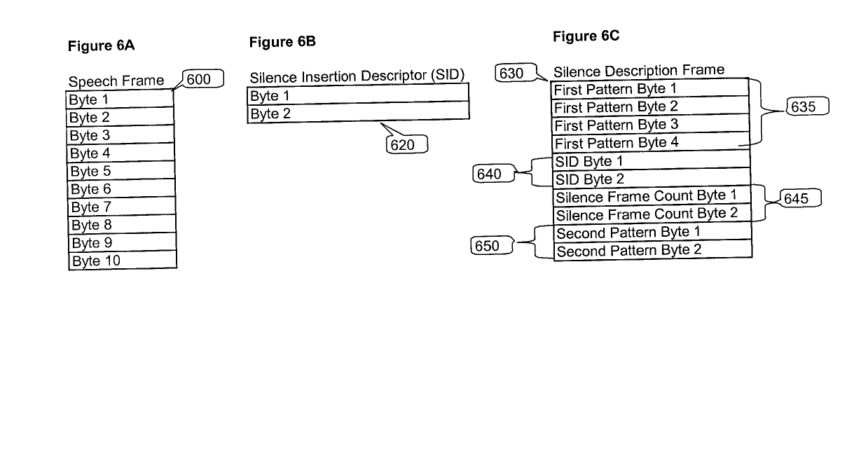

Referring now to FIG. 6A, FIGS. 6B and 6C there are shown examples of an encoded speech frame 600, a silence insertion descriptor (SID) 620, and a silence description frame 630. FIG. 6A shows a 10-byte encoded speech frame 600. The encoded speech frame 600 represents a uniform frame size for all active frames encoded by a low bit rate speech codec. Each speech frame 600 may be received in an individual packet and may represent 10 milliseconds of speech.

FIG. 6B shows an SID for this codec. When a codec determines a speech frame comprises substantially no speech, the codec may encode a pattern representing comfortable noise to simulate a silence. The parameters of the comfortable noise may be adjusted to match background noise of the speech being encoded. A gateway may receive the SID from the codec and packet a single SID 620 in a 2-byte packet. The gateway transmit the SID packet and stop transmitting packets until a speech frame 600 is received from the encoder.

FIG. 6C represents a silence description frame 630 determined or selected for the speech codec that encoded speech frame 600. The silence description frame 630 is determined to comprise a total of 10 bytes to match the size of the speech frame 600 and to comprise a first pattern 635, a SID 640, a silence frame count 645, and a second pattern 650. A first pattern 635 may comprise 4 bytes to distinguish the silence description frame 630 from the speech frame 600. The SID 640 may comprise the same 2-byte description of silence received as a packet from a gateway to describe the comfortable noise for the speech. The silence frame count may comprise 2 bytes containing a count of the number of untransmitted frames that represent silence frames. Finally, the second pattern 650 may comprise 2 bytes to indicate the end of the silence description frame 630.

What is claimed is:

1. A method, comprising:
counting an untransmitted frame;
determining a silence description frame; and
storing a silence description frame.

2. The method of claim 1 further comprising:
receiving an active frame; and
storing the active frame.

3. The method of claim 1 further comprising decoding a file comprising an active frame and a silence description frame.

4. The method of claim 1 further comprising receiving a packet describing comfortable noise.

5. The method of claim 1 wherein said counting an untransmitted frame comprises determining an untransmitted frame represents a silence frame.

6. The method of claim 1 wherein said counting an untransmitted frame comprises determining a sequence of frames comprises a silence frame.

7. The method of claim 1 wherein said determining a silence description frame comprises determining a pattern to demarcate the silence description frame.

8. The method of claim 1 wherein said determining a silence description frame comprises determining a frame to decode as an invalid frame.

9. The method of claim 1 wherein said determining a silence description frame comprises selecting a size of the silence description frame equivalent to the size of an active frame.

10. The method of claim 1 wherein said storing the silence description frame comprises storing the silence description frame adjacent to an active frame.

11. An apparatus, comprising:
a network interface; and
a silence description frame filer coupled to said network interface; and
a data storage device coupled to said silence description frame filer.

12. The apparatus of claim 11, further comprising a decoder to decode a file comprising an active frame and a silence description frame.

13. The apparatus of claim 11, wherein said network interface comprises a packet-switching interface.

14. The apparatus of claim 11, wherein said silence description frame filer comprises a microprocessor coupled to said data storage device.

15. The apparatus of claim 11, wherein said silence description frame filer comprises a microprocessor to count an untransmitted frame.

16. The apparatus of claim 11, wherein said silence description frame filer comprises a microprocessor to determine a silence description frame.

17. The apparatus of claim 11, wherein said data storage device comprises a data storage controller coupled to said silence description frame filer.

18. The apparatus of claim 11, wherein said data storage device comprises a memory device coupled to said silence description frame filer.

19. A system, comprising:
a variable-size packet transmitter; and
a silence description frame filer coupled to said variable-size packet transmitter.

20. The system of claim 19, further comprising a decoder coupled to an output device.

21. The system of claim 19, wherein said variable-size packet transmitter comprises a microprocessor to encode active audio in a fixed-size packet.

22. The system of claim 19, wherein said variable-size packet transmitter comprises a microprocessor to encode a video difference in a fixed-size packet.

23. The system of claim 19, wherein said untransmitted-frame determiner comprises microprocessor to store a silence description frame.

24. A machine-readable medium containing instructions, which when executed by a machine, cause said machine to perform operations, comprising:
counting an untransmitted frame;
determining a silence description frame; and
storing the silence description frame.

25. The machine-readable medium of claim 24 further comprising:
receiving an active frame;
storing the active frame;

26. The machine-readable medium of claim 24 wherein said counting an untransmitted frame comprises determining a sequence comprises a silence frame.

27. The machine-readable medium of claim 24 wherein said determining a silence description frame comprises determining a pattern to demarcate the silence description frame.

28. The machine-readable medium of claim 24 wherein said determining a silence description frame comprises determining a silence description frame comprises selecting a size of the silence description frame equivalent to the size of an active frame.

29. The machine-readable medium of claim 24 wherein said determining a silence description frame comprises determining a frame to decode as an invalid frame.

30. The machine-readable medium of claim 24 wherein said storing the silence description frame comprises storing the silence description frame adjacent to an active frame.
